(19) United States
(12) Patent Application Publication
(10) Pub. No.: US 2026/0245476 A1
(43) Pub. Date: Aug. 20, 2026

(54) AERIAL IMAGE DISPLAY DEVICE

(71) Applicant: INTERMAN Corporation, Kagoshima-shi, Kagoshima (JP)

(72) Inventors: Yoshimasa SAITOH, Machida-shi (JP); Shigeki UETABIRA, Kagoshima-shi (JP)

(73) Assignee: INTERMAN Corporation, Kagoshima-shi, Kagoshima (JP)

(21) Appl. No.: 19/153,724

(22) PCT Filed: Dec. 28, 2023
(86) PCT No.: PCT/JP2023/047286

§ 371 Date: Aug. 5, 2025

(30) Foreign Application Priority Data
Feb. 11, 2023 (JP) 2023-019553

(51) Int. Cl. G09B 9/22; G09B 9/30

(52) U.S. Cl. CPC G09B 9/22; G09B 9/30

(57) ABSTRACT

The aerial image display device realizes an aerial display by forming an image in mid-air via an optical system. This aerial image display device is provided with a wave field synthesis speaker composed of a large number of small speakers. A virtual sound source, capable of moving to follow the movement of the aerial image, is created at a position overlapping the aerial display by the wave field synthesis speaker. As a result, the system enables diverse expressions in both visual and auditory aspects, accompanied by a sense of floating in which sound is integrated with the motion of the image.

### TECHNICAL FIELD

The present invention relates to an aerial image display device capable of diverse visual and auditory expressions.

### BACKGROUND ART

In recent years, there has been increasing interest in aerial image display devices. One of the reasons for this is the demand for contactless interaction due to the COVID-19 pandemic. That is, they are used as alternatives to touch panels in combination with sensors. For example, in ATMs at banks, self-checkout counters at supermarkets, corporate receptions, and hotel check-ins, an unspecified number of users operate the same touch panel. Such touch panels can potentially serve as infection routes. To avoid this risk, the panel must be disinfected every time the user changes, but such a measure is quite troublesome and difficult to perform adequately.

A contactless interface using an aerial image display device can avoid infection risks without the need for such troublesome procedures, while offering similar usability to conventional touch panels. For example, Patent Document 1 describes a system where, due to hygiene concerns, a surgeon operating during surgery uses a contactless remote pointer control device with an aerial imaging technique to manipulate a mouse, instead of touching a pointing device like a mouse. A special optical element usable for such aerial imaging techniques includes the optical imaging device described in Patent Document 2.

The mere appearance of an image floating in mid-air using aerial imaging technology is impactful and helps create a futuristic atmosphere. Because of this, many applications beyond infection prevention measures are conceivable. For example, if applied to digital signage, it can attract more attention. The technology disclosed in Patent Document 3 shows an example where it is used as a substitute for ticket gates at train stations. Moreover, displaying an image as an aerial image gives a sense of three-dimensionality as it appears to float from the surroundings, making it highly entertaining and promising for applications such as games.

### PRIOR ART DOCUMENTS

### Patent Documents

[Patent Document 1] Japanese Patent Published Application No. 2018-147054

[Patent Document 2] International Publication No. WO 2009/131128

[Patent Document 3] Japanese Patent Published Application No. 2017-142370

### Summary of the Invention

### Problems to be Solved by the Invention

When an image is displayed as an aerial image, the object appears to float in mid-air, enabling a highly realistic and immersive experience. On the other hand, in conventional systems, although the image appears to float, the audio remains flat, and the realism and sense of presence are not high.

Therefore, it is an object of the present invention to provide an aerial image display device that offers a floating sensation for audio as well, similar to that of the image.

### Means to Solve the Problems

To achieve at least one of the above-mentioned objects, reflecting one aspect of the present invention, an aerial image display device capable of displaying an aerial image, comprises: a wave field synthesis speaker composed of a plurality of small speakers configured such that a virtual sound source can move in mid-air, wherein the virtual sound source is generated to overlap with the aerial image.

In one embodiment, the aerial image display device comprises: a display device; a control unit configured to output image signals to the display device; and an optical plate held facing the display surface of the display device at a predetermined angle, wherein when an image is displayed on the display device, the image is formed as an aerial image at a symmetric position on the opposite side of the optical plate.

Furthermore, in one embodiment, the display surface of the display device is convex, and the display surface of the aerial image is concave.

Furthermore, in one embodiment, the aerial image display device is implemented as a visual display device of a flight simulator modeled after a cockpit.

### Effects of the Invention

According to the aerial image display device of the present invention, a variety of expressions in both visual and auditory aspects can be realized, accompanied by a sense of floating where sound is integrated with the movement of the image. In particular, when a large-area aerial display is implemented, the range in which the virtual sound source can move becomes wider, and dramatic effects can be expected. For example, in a system that uses a large optical plate exceeding 1 meter in width, larger wave field synthesis speakers can also be installed, enabling various applications that take advantage of sound effects. One such application could be showing fireworks footage, where the sound moves across the wide screen, achieving a highly effective result.

### BRIEF DESCRIPTION OF THE DRAWINGS

FIG. 1 is a perspective view showing a flight simulator 1 using the aerial image display device according to an embodiment of the present invention.

FIG. 2 is a diagram explaining the principle by which the display screen of a curved display 20 forms an aerial image G via an optical plate 40 in the flight simulator using the aerial image display device according to the embodiment of the present invention. Only the optical plate 40, the display screen of the curved display 20, and the aerial image G of the flight simulator 1 in FIG. 1 are shown from the left side of the simulator.

FIG. 3 is a diagram explaining the principle by which the display screen of the curved display 20 forms the aerial image G via the optical plate 40 in the flight simulator using the aerial image display device according to the embodiment of the present invention. Only the optical plate 40, the display screen of the curved display 20, and the aerial image G of the flight simulator 1 in FIG. 1 are shown from directly above.

FIG. 4 is a diagram explaining the principle by which the display screen of the curved display 20 forms the aerial image G via the optical plate 40 in the flight simulator using the aerial image display device according to the embodiment of the present invention. Only the optical plate 40, the display screen of the curved display 20, and the aerial image G of the flight simulator 1 in FIG. 1 are shown from the front.

FIG. 5 is a diagram explaining the operation of a wave field synthesis speaker of the flight simulator using the aerial image display device according to the embodiment of the present invention.

FIG. 6 is a diagram explaining a display device that replaces the curved display of the flight simulator using the aerial image display device according to the embodiment of the present invention.

### MODE FOR CARRYING OUT THE INVENTION

### Embodiment

Hereinafter, an embodiment of the aerial image display device according to the present invention will be described with reference to the accompanying drawings. In this example, the device is applied to a flight simulator where users can sit in a cockpit mimicking a real one and operate an aircraft while watching the screen, offering a full-scale piloting experience. In particular, it is applied to a competitive-type flight simulator game involving aerial combat with enemy aircraft.

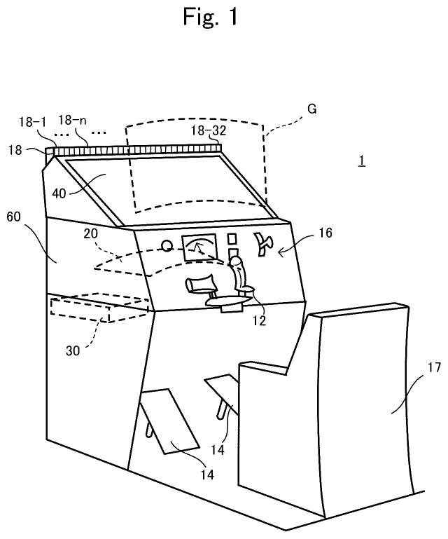

That is, as shown in FIG. 1, the flight simulator 1 serves as a cockpit-like control seat modeled after an aircraft, and consists of a simulator main body 10 and a seat 17 for the pilot operating the flight simulator 1. The simulator main body 10 is equipped with a control stick 12, rudder pedals 14, instrument panel 16, wave field synthesis speaker 18, and other components.

Inside the simulator main body 10, a curved display 20, a control unit 30, and an optical plate 40 are installed. The control unit 30 is connected via internal wiring (omitted in the figure) to the control stick 12, rudder pedals 14, instrument panel 16, wave field synthesis speaker 18, and curved display 20, allowing for signal exchange among them, thereby simulating flight conditions for the boarding experience.

The optical plate 40 is oriented downward with its incident surface facing the display surface of the curved display 20 at a fixed angle (e.g., 45 degrees). The image on the display surface of the curved display 20 is focused again as an aerial image G at a symmetrical position on the opposite side of the optical plate 40, forming an identical image. In other words, the aerial image G is formed at an imaging position in the air, which can be regarded as the configuration of an aerial display.

Of course, the image displayed on the curved display 20 is a flight video (background, enemy aircraft, etc.) generated by the flight simulator 1. The detailed implementation of flight simulation performed in the flight simulator 1, aside from the control of the wave field synthesis speaker 18 described later, is the same as conventional flight simulators and thus will not be described here.

The curved display 20 is a convexly curved liquid crystal display device that is placed nearly horizontally with its display surface facing upward. Here, the curvature of the convex surface is, for example, 1000 R. Instead of a curved liquid crystal display device, a flexible display made of an organic EL display or backlit electronic paper, curved with a desired curvature, may also be used. In any case, it is important that the display surface is convex and faces upward.

In this embodiment, the position of the curved display 20 is fixed, but a support structure may be designed to allow vertical adjustment. In such a case, the focal position of the aerial image G can be adjusted to a position that is easy for the pilot to see.

The control unit 30 is essentially a small computer composed of a CPU (Central Processing Unit), ROM (Read Only Memory), RAM (Random Access Memory), a storage device that stores various programs and data, and input/output interfaces. The input/output interface may include, for example, USB ports and wireless LAN such as Wi-Fi. Through this input/output interface, various data related to flight simulation and program updates can be performed. The control unit 30 outputs image signals to the curved display 20 to perform the display that serves as the basis for the aerial image, and also outputs drive signals to the wave field synthesis speaker 18 to reproduce a sound field synchronized with the image on the curved display 20.

As the optical plate 40, for example, the optical imaging element (two-surface orthogonal reflector) described in Japanese Patent Published Application No. 2011-175297 may be used. This optical imaging element is realized by arranging a large number of planar light-reflecting parts that are orthogonal to each other at regular intervals. Alternatively, a structure such as a two-surface corner reflector with reflective surfaces formed on the sidewalls of square-shaped holes, as described in Japanese U.S. Pat. No. 4,900,618, may be used.

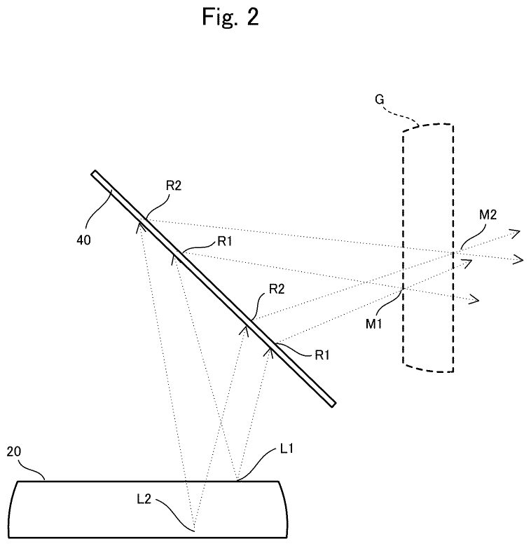

FIG. 2 is a diagram explaining the principle by which the display screen of the curved display 20 forms an aerial image G via the optical plate 40. To simplify the explanation, only the optical plate 40, the display screen of the curved display 20, and the aerial image G of the flight simulator 1 from FIG. 1 are shown from the left side of the simulator.

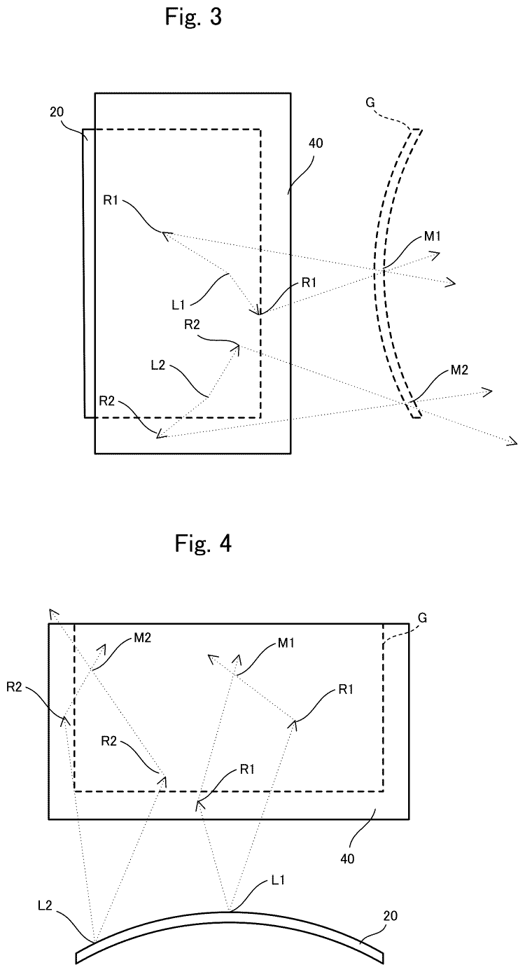

Similarly, FIG. 3 is a diagram explaining the principle by which the display screen of the curved display 20 forms an aerial image G via the optical plate 40. To simplify the explanation, only the optical plate 40, the display screen of the curved display 20, and the aerial image G of the flight simulator 1 from FIG. 1 are shown from directly above.

Furthermore, FIG. 4 is a diagram explaining the principle by which the display screen of the curved display 20 forms an aerial image G via the optical plate 40. To simplify the explanation, only the optical plate 40, the display screen of the curved display 20, and the aerial image G of the flight simulator 1 from FIG. 1 are shown from the front (i.e., from behind the seat 17 in FIG. 1).

Under certain conditions of incident light, the optical plate 40 with a dual-reflection structure such as a two-surface orthogonal reflector or a two-surface corner reflector reflects light incident in the direction of the panel plane recursively while leaving the perpendicular component unchanged. As a result, the display screen of the curved display 20 and the aerial image G form a mirror-symmetric pair with respect to the optical plate 40.

That is, the central horizontal position L1 of the curved display 20 (the most protruded part) is closest to the optical plate 40, and the light emitted from position L1 is focused at position M1, which is also closest to the optical plate 40. In other words, the light from position L1 is reflected at any position R1 on the optical plate 40 and converges at position M1, which is located on the opposite side of the optical plate 40 at a distance equal to the distance between position L1 and the optical plate 40.

Similarly, the outer horizontal position L2 of the curved display 20 is farther from the optical plate 40, and the light emitted from position L2 converges at position M2, which is farther from the optical plate 40. That is, the light from position L2 is reflected at any position R2 on the optical plate 40 and converges at position M2, which is located on the opposite side of the optical plate 40 at a distance equal to the distance between position L2 and the optical plate 40.

As a result, from the pilot seated in seat 17, the aerial image G appears curved inward (concave) in front of them, and the concavely curved aerial display is implemented as if it were floating in mid-air.

In conventional flight simulators using flat displays, the left and right edges of the display appear farther from the eyes and harder to see, and the image at the edges becomes distorted, resulting in a significant difference from the actual field of view. In contrast, with this concavely curved aerial display, the field of view as seen by the pilot during actual flight can be reproduced naturally and without discomfort.

Furthermore, since there is no physical display itself in the aerial display, it provides a more three-dimensional and immersive flight experience. Additionally, with physical displays, external light is inevitably reflected on the display surface, obstructing the pilot's view, but in an aerial display, such reflection is not possible, allowing for a deeper immersive pseudo-flight experience undisturbed by external light.

Next, the wave field synthesis speaker 18, a key component of the present invention, will be described. The wave field synthesis speaker 18 is composed of a row of multiple small speakers 18-1, 18-2, . . . 18-32, each of which is independently controlled by the control unit 30. The more small speakers there are, the higher the accuracy of sound field reproduction. In this example, a line speaker with 32 horizontally aligned small speakers is used. In general, the preferred number of small speakers as components of the wave field synthesis speaker 18 is at least 8, and preferably 16 or more.

The control of the small speakers 18-1, 18-2, . . . 18-32 by the control unit 30 is performed using wave field synthesis (WFS) technology, enabling the realization of a virtual sound source at a predetermined position. Here, realizing a virtual sound source means that, based on Huygens' principle, a sound field is constructed such that within a designated listening area (in this case, near the pilot's head), it seems as though a real sound source exists at the location of the virtual source.

Therefore, the program routine within the control unit 30 for controlling the speakers includes not only audio data such as engine sounds but also positional data that specifies the location where the sound is to be reproduced.

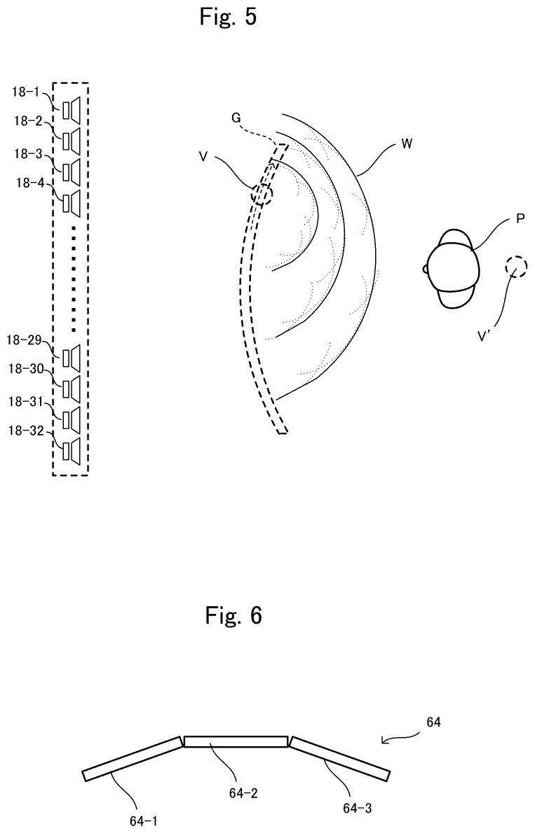

FIG. 5 is a diagram explaining the virtual sound source generated by the wave field synthesis speaker 18 of the present invention. To simplify the explanation, only the wave field synthesis speaker 18 and the aerial display (aerial image) G of the flight simulator 1 from FIG. 1 are shown from directly above.

As shown in FIG. 5, by controlling each of the small speakers 18-1, 18-2, . . . 18-32 using wave field synthesis technology, the individual sound waves overlap to synthesize a wavefront W of a virtual sound source V. In practice, as long as the virtual sound source V is perceptible to the pilot P, it is sufficient for the wavefront W of the virtual sound source V to be reproduced only in front of the aerial display G.

Here, since the application is for a competitive-type game, the virtual sound source V serves as the source for reproducing the engine sound of an enemy aircraft. The virtual sound source V is configured at the position of the enemy aircraft displayed on the aerial display G and moves together with the moving enemy aircraft on the screen, as indicated by the arrow in FIG. 5. Because the wavefront W is faithfully synthesized, the Doppler effect is also reproduced.

In FIG. 5, the virtual sound source V for reproducing the engine sound of the enemy aircraft is shown as moving along the aerial display G (the focal surface), but this is not a limitation. Depending on the movement of the enemy aircraft, the virtual sound source V may be controlled to move forward or backward, popping out in front of or behind the aerial display G. For example, in a scene where the enemy aircraft passes head-on past the user's own aircraft, the virtual sound source V can be made to move behind the pilot P. In such a case, the immersive experience can be enhanced more effectively by slightly increasing the frequency of the engine sound of the approaching enemy aircraft and slightly lowering the frequency as it moves away to the rear, thereby emphasizing the Doppler effect.

Furthermore, since wave field synthesis technology allows for the synthesis of multiple virtual sound sources, the engine sounds of multiple enemy aircraft can be separately reproduced. That is, a virtual sound source is assigned one-to-one to each enemy aircraft. This enables the presence of multiple enemy aircraft to be perceived not only visually but also auditorily. Additionally, by setting a virtual sound source V′ for reproducing the engine sound of the pilot's own aircraft behind the pilot, the sense of immersion is further enhanced.

Generally, when synthesizing a virtual sound source using a wave field synthesis speaker 18, if there is a physical object like a display near the position of the virtual sound source, sound waves may interfere with the object, making synthesis unsuccessful. However, in the present invention, since the aerial display has no physical substance, the virtual sound source can be overlapped with the display, or moved across the front or rear of the display. This enables diverse expressions in both visual and auditory aspects.

In the flight simulator 1 of the above embodiment, a concavely curved aerial image can be displayed seamlessly, but it requires a dedicated curved display, which tends to be costly. As an alternative, the use of a combination of multiple flat-panel displays allows for reduced manufacturing costs.

That is, as shown in FIG. 6, a central flat-panel display 64-2 placed nearly horizontally with its display surface facing upward, and left and right flat-panel displays 64-1 and 64-3 installed in close contact at a fixed angle (e.g., 20 degrees), may be used. In this case, although the result is not a smoothly curved surface like in the above embodiment, a concave display can still be realized as a whole at a lower manufacturing cost by combining inexpensive general-purpose LCD displays.

### INDUSTRIAL APPLICABILITY

According to the aerial image display device of the present invention, a system is realized that enables diverse expressions in both visual and auditory aspects, accompanied by a sense of floating where the sound is integrated with the motion of the image.

The aerial image display device according to the present invention has been described above with reference to the embodiments, but the present invention is not limited thereto, and modifications may be made within the scope not departing from the spirit of the invention, and, if possible, the technologies described in each embodiment may be combined or combined with known technologies.

For example, in the above embodiment, the aerial image display device is applied to a flight simulator modeled after a cockpit, but the application of the present invention is not limited to this. It can also be applied to various types of competitive simulators such as war simulation games set on land or in space, and racing simulators. Furthermore, it can be applied to web conferencing systems where multiple participants are displayed on the screen. By assigning a virtual sound source to each participant and making sound output originate from their display positions, a more realistic sense of presence as if participating in an actual meeting can be achieved.

In the above embodiment, the wave field synthesis speaker is implemented as a single row line speaker installed along the upper edge of the optical plate 40, but the invention is not limited to this. For example, multiple line speakers may be provided along both the upper and lower edges of the optical plate 40, or even along the left and right edges.

In general, aerial image display devices are often equipped with contactless interfaces that allow the user to interact with the aerial image. In the above embodiment, such a contactless interface is omitted because it is modeled after a cockpit. However, depending on the application, a contactless interface that allows operations by touching the aerial image can be very effective. In such cases, as in conventional aerial image display devices, a contactless interface may be implemented by installing an operation detection unit consisting of infrared LEDs and infrared cameras near the aerial image (e.g., in front of the optical plate 40).

Furthermore, although the above embodiment uses a curved display to realize a concavely curved aerial image, this tends to be costly. As an alternative, a single general-purpose flat LCD display may be used. In that case, the aerial image will also be flat, but it poses no problem in implementing the present invention.

In addition, the above embodiment uses an optical system that employs a dual-reflection structured optical plate such as a two-surface orthogonal reflector or a two-surface corner reflector, but the present invention is not limited to this and may also be applied to other types of aerial image display devices. For example, a retroreflective system using a beam splitter as the optical plate 40 combined with a retroreflective panel placed on the rear side may be adopted.

### DESCRIPTION OF REFERENCE NUMERALS

1 flight simulator
10 simulator main body
12 control stick
14 rudder pedal
16 instruments
17 seat
18 wave field synthesis speaker
20 curved display
30 control unit
40 optical plate
64-1, 64-2, 64-3 flat display

1-4. (canceled)

5. An aerial image display device capable of displaying an aerial image in the front direction of a user comprising:
a wave field synthesis speaker located in the front direction of the user and composed of a plurality of small speakers configured such that a virtual sound source can move in mid-air, wherein
as the aerial image, a background and an object as a sound source moving within the background are displayed, and wherein
the virtual sound source is created to overlap with the aerial image, and move together with the object as the sound source within the background.

6. The aerial image display device according to claim 5, implemented as a visual display device for a flight simulator.

7. The aerial image display device according to claim 6, wherein the object as the sound source is an aircraft flying within the background.
